(19) United States
(12) Patent Application Publication
(10) Pub. No.: US 2005/0071241 A1
(43) Pub. Date: Mar. 31, 2005

(54) Contact center resource allocation based on work bidding/auction

(76) Inventors: Andrew D. Flockhart, Thornton, CO (US); Larry J. Roybal, Westminster, CO (US); Robert C. Steiner, Broomfield, CO (US)

Correspondence Address: SHERIDAN ROSS P.C., 1560 BROADWAY, SUITE 1200, DENVER, CO, 80202, US

(21) Appl. No.: 10/673,105

(22) Filed: Sep. 26, 2003

(51) Int. Cl. G06F 17/60

(52) U.S. Cl. 705/26

(57) ABSTRACT

A contact center for servicing a plurality of contacts received from a plurality of customers is provided. The contact center includes:
(a) a plurality of workstations 15 corresponding to a plurality of resources 14;
(b) a central server 10 in communication with the plurality of workstations, comprising:
   (i) at least one queue 42, 46 and/or 66 of contacts; and
   (ii) a bid item selecting agent 74 operable to (a) request at least some of the plurality of resources to submit a bid to service at least one contact; (b) receive at least one bid to service the at least one contact; and (c) select a resource from among the plurality of resources to service the at least one contact.

### CROSS REFERENCE TO RELATED APPLICATIONS

The present application has subject matter related to U.S. patent application Ser. No. ______, entitled “METHOD AND APPARATUS FOR BUSINESS TIME COMPUTATION IN A RESOURCE ALLOCATION SYSTEM” to Flockhart et al., filed herewith and incorporated herein by this reference.

### FIELD OF THE INVENTION

The present application is directed generally to contact centers and specifically to methodologies and systems for servicing work such as contacts, particularly during periods of peak volume.

### BACKGROUND OF THE INVENTION

In automatic contact-distribution (ACD) systems, contacts incoming to a contact center are answered and handled by a plurality of resources. The ACD system automatically distributes and connects incoming contacts to whatever resource, such as agents, have the skill set suited to handle the contacts and are free, i.e., not handling other contacts at the moment. As used herein, a “contact” refers to any mode or type of contact between two entities, including without limitation voice calls, VoIP, text-chat, e-mail, fax, electronic documents, web forms, voice messages, and video calls, to name but a few.

Due to the random and peaked nature of inbound contacts from customers, a contact center frequently becomes overloaded when no suitable resources are available to handle contacts as the contacts come in. The contacts are placed in different queues based upon some preestablished criteria, such as business/service policies, objectives, and goals for each contact type, and are placed in each queue in the order of their arrival and/or priority. Numerous techniques have been devised for determining an actual or anticipated wait time for each enqueued item, and the enqueued items are typically serviced based on the actual and/or anticipated wait time. In more elaborate systems, business/service policies, objectives, and goals and/or the degree to which they are realized are considered in selecting which work item is to be routed to an available resource. Although this approach is effective in many applications, the approach can lead to a valuable resource being tied up on a work item of little value, not only causing inefficient use of contact center resources but also leading to frustration of more valuable customers due to long wait times and/or service by a less skilled resource.

### SUMMARY OF THE INVENTION

These and other needs are addressed by the various embodiments and configurations of the present invention. The present invention is directed generally to a method for allocating work items, such as contacts, among a plurality or set of resources using competitive bidding. The methodology is particularly useful in contact centers.

In one embodiment, items of work, such as contacts, product orders, and service requests, are presented, for competitive bidding, to resources identified as being competent to perform the work. In a contact center architecture, the bidders may be internal or external to the contact center. A part of the bid for the work is typically an expectation that the work will meet one or more goals, such as being done by a set time. When the combination of resource skills and bid price cross a determined threshold, the work is assigned. Bidding thresholds may be predetermined or dynamically adjusted, ensuring that work is eventually completed. During work shortages, a resource can maintain an entry bid for many types of work and can automatically be entered in the bidding when new work arrives. When compared to existing work allocation methodologies in contact centers, this bidding process can more effectively and optimally allocate internal resources.

The work may be routed to differing bidding and nonbidding sets of resources depending on the value of the work item and whether or not a work surplus exists. Typically, work is not presented to external resources during times when there is no work surplus. When a work surplus exists, work with low value is generally presented to internal bidders with lower skill sets and/or bid out to external resources, either singularly or in blocks of work. By identifying groups of less profitable or valuable work that may be better off presented to external or outside bidders and groups of highly valuable work that can be presented to internal or inside bidders, the overall performance of an enterprise can be heightened.

During times when work may be lost or become late due to large amounts of surplus work, initial bid prices may rise to compete for the resources to resolve the surplus. Furthermore, this methodology can provide an effective technique of load shedding and/or freeing valuable resources to handle imminent, valuable work and/or work that may be increasingly time sensitive. This methodology is particularly advantageous when forecasting techniques are used to determine when, in the future, a resource shortage or work surplus will occur, allowing ample time for the bidding process to finish, bringing the required resources online at the appropriate time.

When work is provided to external resources, such as external resource houses, the currency of the bidding can be real dollars and cents, while internal offers can be bid based on other criteria, such as skill sets and proven track records. A method of normalizing these disparate forms of currency may be provided so that the contact center may make appropriate comparisons.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram of a contact center according to an embodiment of the present invention;

FIG. 2 is a flow chart depicting the operation of a workload monitoring resource according to an embodiment of the present invention;

FIG. 3 is a flow chart depicting the operation of a bid item selecting resource according to an embodiment of the present invention;

FIG. 4 is a flow chart depicting the operation of the bid item selecting resource according to yet another embodiment of the present invention;

FIG. 5 depicts an embodiment of a table used by the bid item selecting item resource in the bidding process; and

FIG. 6 is a plot of work item volume (vertical axis) versus time (horizontal axis).

### DETAILED DESCRIPTION

### The Multi-Media Contact Center

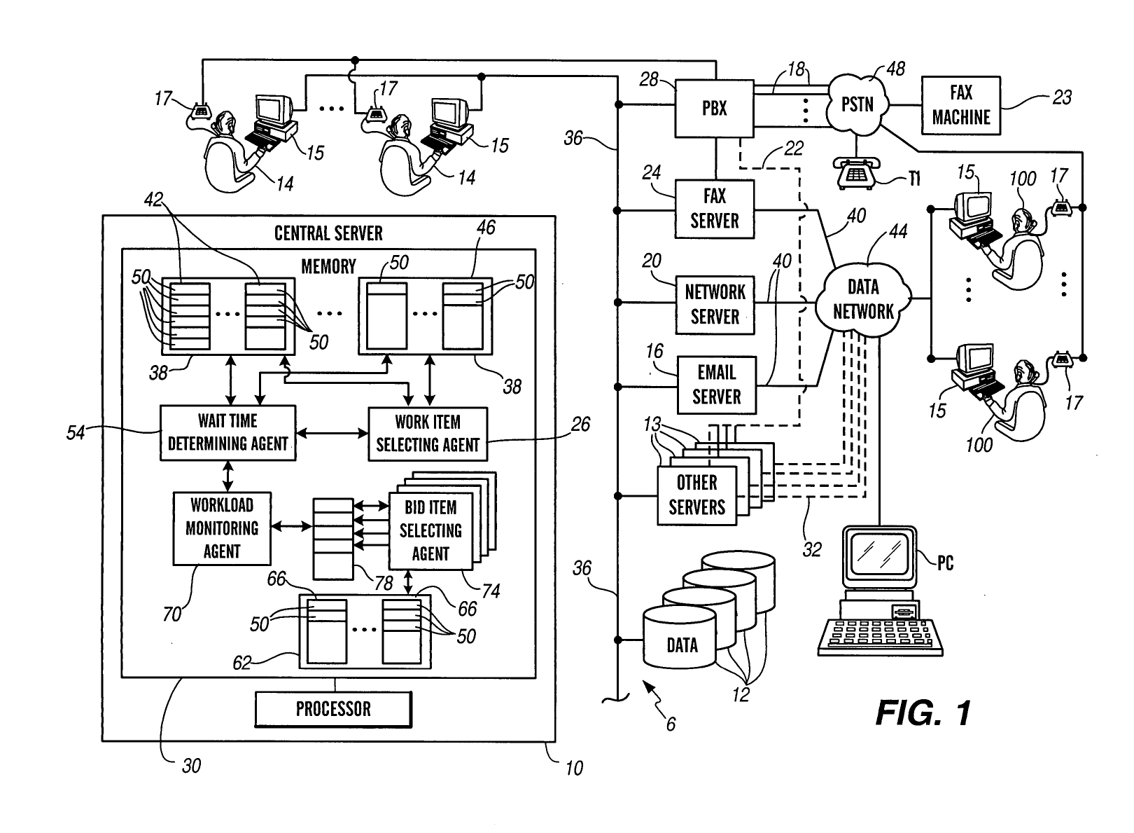

FIG. 1 shows an illustrative embodiment of the present invention.

A contact center 6 comprises a central server 10 (such as a Definity™ or Multi-Vantage™ Enterprise Communications Server running modified Advocate™ software of Avaya, Inc.), a set of data stores or databases 12 containing contact or customer related information and other information that can enhance the value and efficiency of the contact, a plurality of servers, namely a fax server 24, a data network server 20, an email server 16, and other servers 13, a private branch exchange PBX 28 (or private automatic exchange PAX), a first plurality or set of resources 14 (which are shown as being human agents) operating computer work stations 15, such as personal computers, and/or telephones 17 or other type of voice communications equipment, all interconnected by a local area network LAN (or wide area network WAN) 36, and a second plurality or set of resources 100 (which are shown as being human agents) also operating computer work stations 15, such as personal computers and/or telephones 17 or other types of voice communications equipment, connected to the PBX 28 via a public switched telephone network or PSTN 48 and to the central server 10 via a data network 44, such as the Internet. The fax server 24, web server 20 and email server 16 are connected via communication connections 40 to the data network 44.

The other servers 13 can be connected via optional (dashed) communication lines 22, 32 to the PBX 28 and/or the data network 44. As will be appreciated, other servers 13 could include a scanner (which is normally not connected to the PBX 28 or network 44), interactive voice recognition IVR software, VoIP software, video call software, voice messaging software, an IP voice server, and the like. The PBX 28 is connected via a plurality of trunks 18 to the PSTN 48 and to the fax server 24 and telephones 17 of the resources 14. As will be appreciated, faxes can be received via the PSTN 48 or via the network 44 by means of a suitably equipped personal computer. The PBX 28, fax server 24, email server 16, web server 20, and database 12 are conventional.

As will be appreciated, the central server 10 is notified via LAN 36 of an incoming realtime or non-realtime contact by the telecommunications component (e.g., PBX 28, fax server 24, email server 16, web server 20, and/or other server 13) receiving the incoming contact. The incoming contact is held by the receiving telecommunications component until the central server 10 forwards instructions to the component to forward the contact to a specific workstation and/or resource. The server 10 distributes and connects these contacts to workstations of available resources based on a set of predetermined criteria. The resources process the contacts sent to them by command of the central server 10.

In the architecture of FIG. 1 when the central server 10 forwards a realtime contact such as a telephone call to a resource, the central server 10 also forwards information from databases 12 to the resource's computer work station for viewing (such as by a pop-up display) to permit the resource to better serve the customer. The information is typically effected by the establishment of a data communications link between the central server and the target resource's workstation.

In one configuration, the first and second pluralities or sets of resources correspond, respectively, to employees and nonemployees of the business or enterprise operating the contact center. For example, the second plurality or set of resources can be contractors, subcontractors, employees of another organization, such as a bidding house, and the like. The first plurality of resources are served directly or supported by the central server/PBX and commonly service contacts to the center. In other words, the first plurality of resources or set of resources/workstations are subscribers to the enterprise network defined by the contact center 6 or are within the premises serviced by the server/PBX. The second plurality or set of resources/workstations are generally not served and/or supported directly by the central server and are typically geographically dislocated from the first plurality or set of resources. In other words, the second plurality of resources or set of workstations/resources are not subscribers to or supported by the enterprise network and are external to the premises serviced by the PBX and central server. The second set of resources may thus be “external” in that they are not directly supported as terminal endpoints by the server.PBX (e.g., they do not have an extension associated with an internal endpoint serviced by the switch/server). Communications with these resources are directed through the PSTN 48 (for telephone calls) (and are received at an external port of the switch/server) and through the data network 44 (for data communications such as customer-related information transmission). As discussed below, the second set of resources may be used to augment or support the first set of resources, such as by servicing less valuable or profitable work items.

The memory 30 includes a plurality of first sets 38 of contact queues 42 and 46 corresponding to the first plurality of resources and one or more second sets 62 of contact queues 66 corresponding to the second set of resources. Each set of contact queues conventionally serves and holds contacts (or work items) for a different work type and/or for real- versus non-realtime contacts. In the depicted embodiment, queues 42 serve non-real-time contacts while queues 46 serve real-time contacts. This embodiment is particularly suited for a Customer Relationship Management (CRM) environment in which customers are permitted to use any media to contact a business. In a CRM environment, both realtime and non-realtime contacts must be handled and distributed with equal efficiency and effectiveness. Within each set of queues, each queue holds contacts of a different priority and/or different type (e.g., e-mail, fax, electronic or paper documents, webform submissions, voice messages, voice calls, VoIP calls, text chat, video calls, and the like). The priority of a contact is determined according to well known predefined criteria. Each queue normally functions as a first-in, first-out (FIFO) buffer memory, and includes a plurality of entries, or positions 50, each for identifying a corresponding one enqueued contact. The position 50 at the head of the queue is considered to be position 1, the next subsequent position 50 to be position number 2, and so forth.

Memory 30 further includes a wait time determining agent 54. As its name implies, this agent determines an estimate of how long a contact that is placed in a queue will have to wait before being delivered to a resource for servicing and/or has already waited for servicing. The estimate is derived separately by the agent 54 for each queue of each set.

For realtime contacts, the estimate is based on any suitable algorithm, such as the average rate of advance of contacts through positions 50 of the contacts' corresponding queue or other measure of predicted or expected wait time. An illustrative implementation of the agent 54 for real-time contacts is disclosed by U.S. Pat. No. 5,506,898, which is incorporated herein by this reference.

For non-realtime contacts, the estimate is generally determined differently than for realtime contacts. One approach for calculating the wait time is set forth in U.S. patent application Ser. No. 09/641,403, filed Aug. 17, 2000, entitled “Wait Time Prediction Arrangement for Non-Real-Time Customer Contacts”, which is incorporated herein by this reference.

Memory 30 can further include a work item selecting agent 26. Agent 26 is conventional. It selects a next work item from one or more of the queues to be serviced by an available resource based on wait time and/or business/service policies, objectives, and goals for each contact type. This feature is further described in U.S. Pat. No. 5,905,793, which is incorporated herein by this reference.

The memory further includes a workload monitoring agent 70 for determining when work items are to be put out to the second set of resources for bid (or when the contact center workload is such that the contact center is in a bidding mode as opposed to a non-bidding mode), a bid item selecting resource 74 for configuring and tracking the bidding process for each work item and selecting the winning bidder for each such work item, and one or more queues 78 of work items which are each the subject of a current (unresolved) bidding process.

The workload monitoring agent 70 receives wait time information from the wait time determining agent 54, monitors the length of each queue in the first sets of queues 38, the numbers of available resources in the plurality of first resources, the types and priorities of contacts in each monitored queue, and/or anticipated workload levels, and, based on this information, determines when the contact center must put work out for bid to meet predetermined business/service policies, objectives, and goals for each contact type.

In one configuration discussed in copending U.S. patent application “Methodologies for Assessing the Status of Work Waiting for Service”, filed herewith, to Flockhart et al., which is incorporated herein by this reference, the agent 70 predicts when one or more enqueued work items may fail to meet their goals. In this configuration, all work items in a queue 42, 46 are scanned and a Required Queue Position or RQP “N” is calculated for each scanned item. RQP is an assessment that, to meet its service-time goal, the scanned work item must be serviced by one of the next “N” resources to become available to service the type of work to which the work item pertains. A representation of a required queue is generated during this scan. The required queue is then analyzed when all work items have been assessed and assigned to their required positions. In a simple example, when more than one work item must be serviced next to meet its service-time objective(s), there is an obvious and imminent problem of inadequate staffing. When the scan is complete, for each queue position N in the required queue, the work items in queue positions 1 through N are summed. If the sum is greater than N, there is a potential future problem. The position in the required queue, N, where the problem is detected, gives an indication of when the problem is expected to arise. The extent by which the number of work items assigned exceeds N gives an indication of the seriousness of the problem.

This methodology permits not only the number of items to be put out for bid to be determined (the number by which the number of work items assigned exceeds N) but also the time available for the bidding process (when in the future the problem is expected to arise). For example, if no work items are assigned to the first three queue positions in the required queue, but six work items are assigned to queue position 4, it is known that there is a potential future problem, the problem is not expected to arise until the wait time for each of the preceding positions in the required queue has expired, and the allocation of two additional resources or resources within that time period will be required to avoid the potential problem.

This configuration is further illustrated graphically by FIG. 6. As shown in FIG. 6, the rate at which work items can be handled as a function of time is represented by line 600. The sinusoidal waveform 604 represents the number of work items that must be serviced by the resources as a function of time. There is a surplus of available resources earlier than time t₂ and a surplus of work items after time t₂. If the workload monitoring agent 70 detects the surplus work item condition at time t₁, the resource must put an appropriate number of surplus work items out for bid and have the bidding process completed and the work items assigned to one or more of the members of the second set of resources no later than time t₂. Returning again to FIG. 1, the bid item selecting agent 74 receives from the workload monitoring agent 70 the number(s) and identities of the enqueued work items that must be handled by resources in the second set of resources and the time by which bidding for each work item is to be completed. Using this information, the selecting agent 74 configures the bidding process parameters, namely when to publish the solicitation for bids to selected second resources in the plurality of second resources and when to cutoff the acceptance of further bids.

### The Operation of the Workload Monitoring Agent

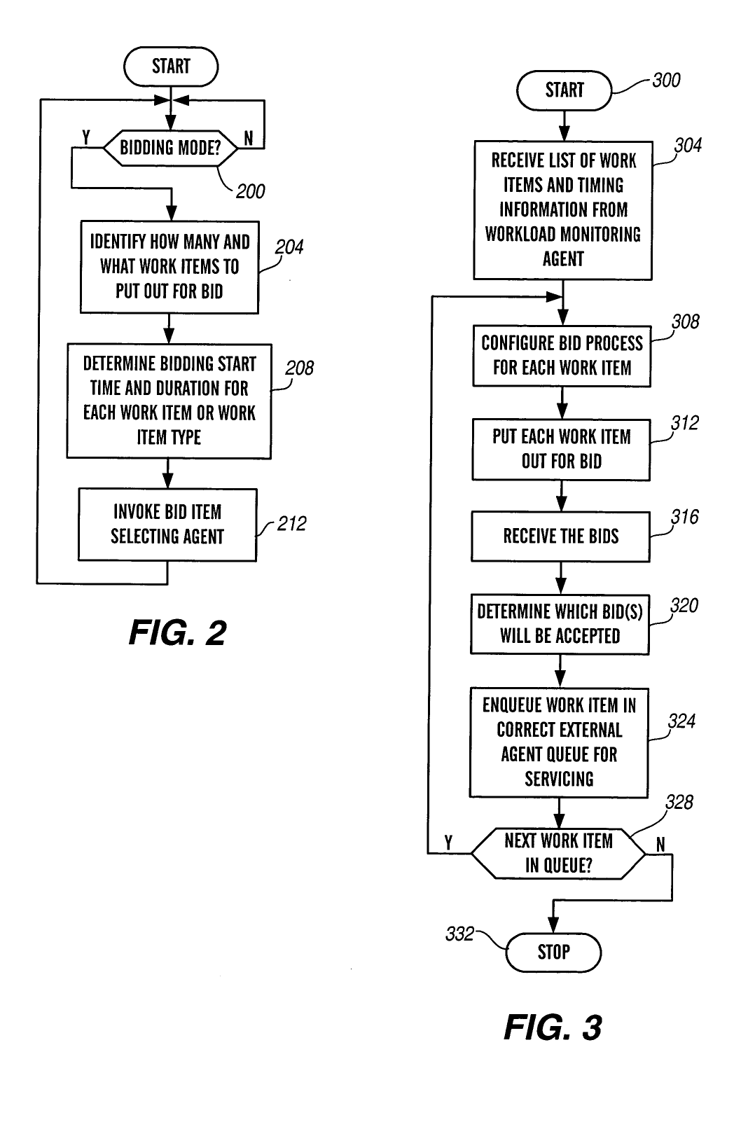

The operation of the workload monitoring agent 70 will now be described with reference to FIG. 2. Referring to FIG. 2, the agent in decision diamond 200 determines whether or not the contact center workload requires invocation of the bidding mode or state. As noted above, this determination is typically based on the current length of or number of work items in each queue in the first set of queues, the numbers of resources in the first set of resources that are currently available/unavailable and/or available/unavailable during selected future time interval(s), the types and priorities of contacts in each monitored queue, and/or anticipated future workload levels or queue lengths.

If the bidding mode is not determined to be desirable and/or required, the agent 70 repeats decision diamond 200 at a configurable time interval.

If the bidding mode is determined to be desirable and/or required, the agent 70, in step 204, determines how many and what work items to put out for bid. The determination of how many work items was discussed above. It is typically based on anticipated or expected future work item surplus levels. The determination of what work items to put out for bid can be based on any of a number of different factors. These factors include the relative values of the work items (e.g., with lower value work items being sent out for bid), the skill levels of the available resources in the second set of resources, and/or the types of work items. As will be appreciated, the “value” of a work item can be based on a number of metrics or other information, such as on one or more of the identification of a customer, a file address associated with the customer, the historical business relationship with the customer, socioeconomic and/or demographic information associated with the customer, an estimated business value of the customer, one or more of the items in an order or collection of item(s) of the customer associated with the current contact, a value of one or more of the items in the collection of item(s), and/or a URL being viewed by the customer when the customer initiated the contact and the URL's value to the business. In some applications, the second set of resources may be more highly skilled than the first set of resources and therefore higher value work items may be sent out for bidding, and in other applications the second set of resources may be less skilled than first set of resources and therefore lower value work items may be sent out for bidding.

In step 208, the agent 70 determines the time available for bidding initiation, performance, and closure and assignment of the work item to the successful bidder. With reference to FIG. 6, the agent determines the time t₂. Depending on the application, it may be desirable for the agent to reduce time t₂ by a selected amount to ensure that adequate staffing is procured before a workload surplus condition is experienced. Such a reduction reflects the inherent inaccuracy of any prediction of future workload conditions. It is generally preferably to allow as much bidding time as possible to receive lower bids for the work item.

In step 212, the agent 70 invokes the bid item selecting agent 74, places the work items in the bidding queue 78 based on their relative bidding end times (with the nearest end time being at the head of the queue and the furthest end time being at the tail of the queue), and provides to the agent 74 the identities of each work item to be put out for bid and, for each identified work item, the time by which bidding is to be completed and the work item assigned to a resource. The identity of the work item can be a pointer to the memory location of the corresponding enqueued entry or of other information relating to the work item.

### Operation of the Bid Item Selecting Agent in a Closed Bidding System

An embodiment of the operation of the bid item selecting agent 74 will now be discussed with reference to FIG. 3.

In step 300, the agent 74 is instantiated and in step 304 the agent receives the list of work items and timing information from the workload monitoring agent 70. As will be appreciated and as shown in FIG. 1, a bid item selecting agent 74 is typically invoked for one work item to be put out for bid. A plurality of agents 74 are therefore in operation at any one time. However, a single agent 74 can be configured to handle in parallel the bidding for each of a plurality of work items.

In step 308, the agent 74 configures the bid process for the received work item. This typically entails the agent 74 identifying the appropriate resource or pool of eligible resources in the second set of resources to service the item and the start time and end time for the bidding on the item. The pool of eligible agents or resources can be determined based on any suitable criteria, such as the skills suitable for servicing the item, and the value of the item, and/or the resource performance history.

In step 312, the agent 74 puts each work item out for bid. This step may be effected by any suitable technique, such as publishing or displaying on the workstation of each eligible resource, a description of the work item (which may be as detailed as desired), a maximum acceptable bid or determined threshold, the closure time for bidding, and/or whether bids may be changed and if so how many times. As will be appreciated, the maximum acceptable bid may be maintained confidential by the contact center. When this approach is utilized, a bidder may be given an indication whether or not his or her bid is less than, greater than, or equal to the maximum acceptable bid for the work item. If the maximum acceptable bid is not met, the work item can be returned to one of the first set of queues for servicing by a resource in the first set of resources. The maximum bid can be based on any suitable metric, such as the value of the work item to the contact center, and the cost for one of the first set of resources to service the item. As will be appreciated, the maximum acceptable bid may be dynamically adjusted to reflect the amount of surplus work available to be serviced.

In step 316, the agent 74 receives bids to service the published work item. As will be appreciated, resources can elect to have the agent automatically post or submit a predetermined bid on any work item that they are eligible to service.

In step 320, the agent, after closure of bidding, determines which bid is acceptable for the work item. The determination may be made in any suitable fashion, such as taking the lowest bid, calculating a composite value for each resource based on the value of the work item, the bid, and/or the skill/experience level or value of the resource and selecting the resource having the lowest (or highest) composite value, and comparing the bids to the determined threshold and taking the resource with highest skill level.

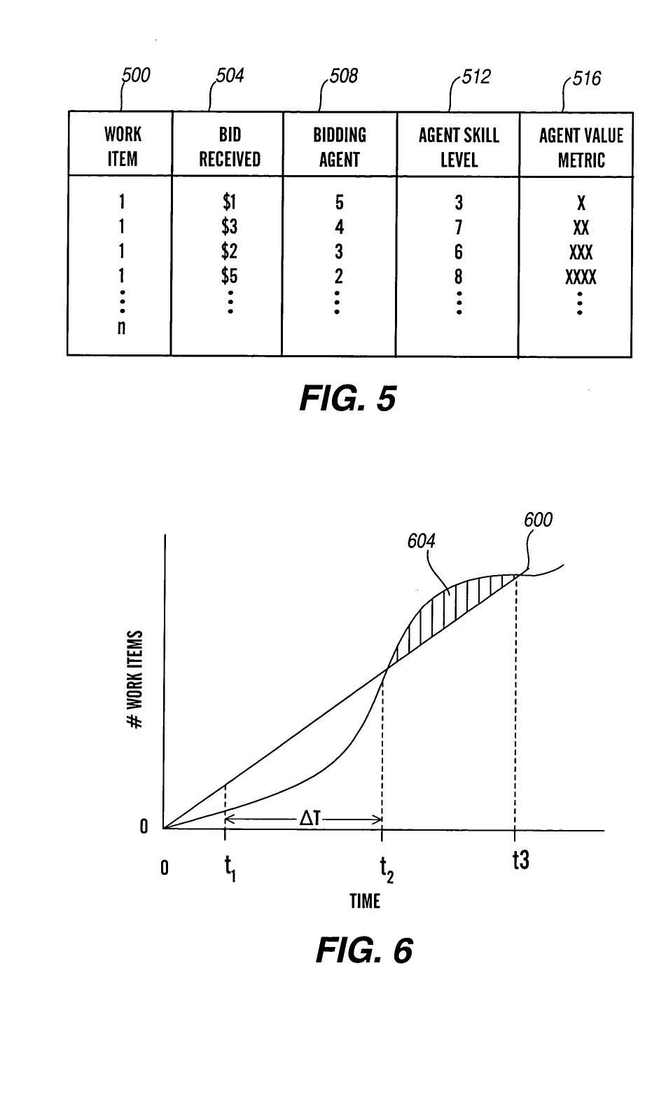

A data structure used in one configuration of a bid selection process is depicted in FIG. 5. Referring to FIG. 5, the work item is identified in column 500, the bid received in column 504, and the bidding resource in column 508, and resource skill level in column 512. These columns are maintained by the agent(s) during step 316. The resource value metric in column 516 is computed based on the information in columns 504 and 512. For example, the metric can be determined by dividing the resource skill level by the bid received or vice versa to obtain a measure of the bid relative to the skill level of the resource. The contact center may be willing to pay more for a more skilled resource or conversely unwilling to pay above a certain amount for a less skilled resource. In some configurations, a further column (not shown) is included for the value of the work item when the value of the work item is considered during resource selection.

In another configuration, a table (not shown) is maintained that cross references resource value ranges with maximum acceptable bids for each value range. Thus, a resource of low value (e.g., low skill level, low experience level, poor service history, etc.) will only be considered eligible for servicing an item if his bid is less than the maximum acceptable bid. The lowest bid selection is made from among all of the resources having bids lower than the maximum acceptable bid for their corresponding value ranges. A similar approach can be used for customers, namely customer value ranges with a corresponding maximum acceptable bid for each range. The maximum acceptable bid can be adjusted dynamically to reflect varying degrees or volumes of surplus work items. The contact center, for example, may be willing to pay more for servicing work items when higher volumes of surplus work items are experienced.

Returning again to FIG. 3, in step 320 the agent, after selecting a resource, removes the work item from the bidding queue 78 and enqueues the work item in an appropriate queue in the second set 62 of queues to be serviced by the corresponding resource. In one configuration, the agent 74 queries the workload monitoring agent 70 to determine whether the circumstances of workload versus employed resource levels have changed since the item was sent out for bid. If the circumstances now make it possible for a resource in the first set of resources to service the work item, the agent, before accepting the bid of the selected resource, can return the work item to the first set of queues and notify the selected resource or all of the bidding resources in the second set that the work item will not be serviced by the selected resource.

In step 328, the agent determines whether there is another work item for bidding in the queue 78. If so, the agent returns to step 308 for that work item. If not, the agent terminates operation in step 332.

### Operation of the Bid Item Selecting Agent in an Open Bidding System

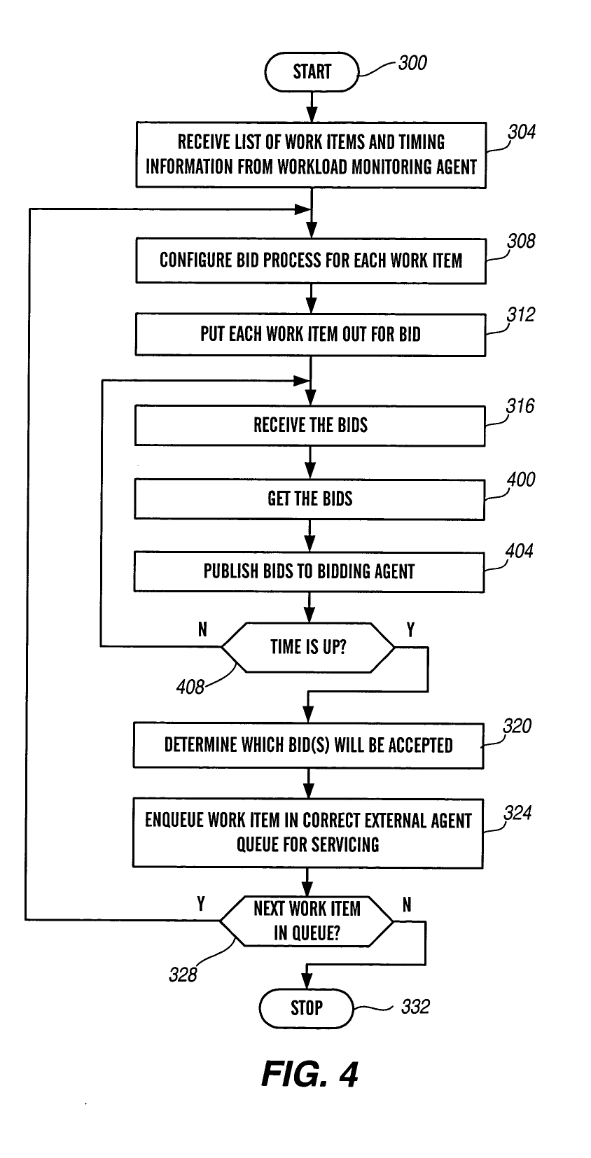

The agent 74 configuration of FIG. 3 is for a closed bidding system. In other words, the bids submitted by each resource are not published to the other resources. Although this configuration may be beneficial in many applications, there are other applications where it is desirable to have an open bidding system, e.g., to publish the lowest bid to other resources to drive the bid to lower levels. The current lowest bid and time remaining to bid cutoff would be presented to each of the eligible resources. This configuration is depicted in FIG. 4.

Referring to FIG. 4, steps 300, 304, 308, 312, 316, 320, 324, 328, and 332 are the same as above. Steps 400, 404, and 408 are different. In step 400, the various bids received from the bidding resources are collected after all or a predetermined number of eligible resources have submitted a bid and/or a configurable time interval has passed since the bid was published and a table similar to the table of FIG. 5 updated to reflect the bids. In step 404, the lowest bid is selected from the table and the lowest bid and/or identity of the resource submitting the lowest bid published to the eligible resources to provide them with the opportunity to submit a further competitive bid.

In decision diamond 408 the agent determines whether or not a predetermined time interval has expired. If time is not up, the steps 316, 400, and 404 are repeated. As will be appreciated, steps 316, 400, and 404 can be completed as many times as desired and/or permitted by the allowable time for completion of the bidding process. The publication in step 404, for example, can be performed as frequently as new bids are received. If time is up, the agent proceeds to step 320.

A number of variations and modifications of the invention can be used. It would be possible to provide for some features of the invention without providing others.

For example in one alternative embodiment, the above described bidding methodology can be employed not only in contact centers, such as call centers, but also automated business systems.

In another alternative embodiment, the above described invention is used with nonhuman resources, such as computational components and machines, in addition to or in lieu of human agents. Examples of such nonhuman resources include interactive voice response or IVR devices, and pre-recorded audio and/or video presentations.

In yet another alternative embodiment, each of the resources in the first and second groupings/sets of resources bid on work items. In other words, a bidding process is used by employee resources to identify who is best suited to service a selected work item. The “bid” can be a metric other than a service fee, which is used for external resources. For example, the “bid” can be a service cost to the contact center, such as the time required by the resource to service the item, a prior history of the resource with the customer corresponding to the work item, a skill level of the resource that is related to the nature of the work item, an opportunity cost to the contact center, an overhead cost to the contact center, and the like. In one configuration, external and internal resources are both submitting bids on work items, but differing bid metrics are used by the two groups of resources. For example, internal resources can submit bids based on expected service time for the work item while external resources submit bids based on service cost or charge in dollars. A suitable algorithm, such as a dollar multiplier to the expected service time, is used to reconcile or provide a common comparison basis for the different bid bases.

In yet another embodiment, the various agents discussed above can be implemented using software and/or a logic circuit, such as an Application Specific Circuit or an ASIC.

In yet another embodiment, the functions of the various agents are allocated or distributed in a different manner than that set forth above. For example, the configuration of the bidding process can be performed by the workload monitoring agent such that the bid item selecting agent simply follows the parameters in conducting bidding.

In yet a further alternative embodiment, the bidding process is used with mobile resources that service work items at different geographic locations. For example, the resources can be contracted service personnel who perform repair and/or maintenance work at business and/or residential locations.

In yet another embodiment, a plurality or batch of work items can be presented as part of a service package for bid to a pool of eligible resources. This can be more computationally efficient for the contact center and more economically attractive for the bidding resources.

In yet another embodiment, there are no bidding and nonbidding modes. Rather, the contact center is continuously placing work items out for bid to resources.

In yet another embodiment, the time allowed for performance and completion of bidding can be varied dynamically work item by work item depending on the circumstances and/or be predetermined based on the work item type and/or customer value.

In yet another embodiment, the PBX and central server are combined into one computational component. In other words, the term “server” as used herein should be understood to include a PBX, an enterprise switch, or other type of telecommunications system switch, as well as other types of processor-based communication control devices such as servers, computers, adjuncts, etc.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g. for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method for allocating work items in a contact center, comprising:
(a) providing a set of resources operable to service a work item;
(b) requesting at least some of the resources in the set of resources to submit a bid to service the work item;
(c) receiving at least one bid to service the work item; and
(d) based at least in part on the at least one bid, selecting a resource from among the set of resources to service the work item.

2. The method of claim 1, wherein the set of resources comprises a plurality of resources external to the contact center.

3. The method of claim 1, further comprising:
identifying a subset of resources from among the set of resources qualified to service the work item; and wherein, in the requesting step, a bid request is provided to each of the resources in the subset of resources.

4. The method of claim 1, wherein the requesting, receiving and selecting steps are performed only during a bidding operational mode.

5. The method of claim 1, wherein the requesting step comprises:
monitoring at least one queue of work items, the at least one queue of work items corresponding to a first set of resources for servicing work items in the at least one queue;
when a predetermined workload level exists in the at least one queue, performing steps (b) through (d); and
when a predetermined workload level does not exist in the at least one queue, not performing steps (b) through (d).

6. The method of claim 5, wherein the predetermined workload level exists when there is a likelihood that a service goal for at least one work item in the at least one queue will not be satisfied.

7. The method of claim 1, wherein the requesting step comprises:
determining a time interval for performance of steps (b) through (d).

8. The method of claim 5, wherein the monitoring step comprises:
determining, from the at least one queue, a representation of a required queue for at least one goal to be realized for each work item in the at least one queue.

9. The method of claim 8, wherein the predetermined workload level exists when a queue position in the required queue is less than a number of work items ahead of the queue position in the required queue.

10. The method of claim 5, further comprising:
determining a time when the predetermined workload level will likely exist.

11. The method of claim 5, further comprising:
determining a number and identities of work items to be presented for bidding to the set of resources.

12. The method of claim 1, wherein the selecting step comprises:
comparing the received bids with a maximum acceptable bid.

13. The method of claim 1, wherein the selecting step comprises:
determining, for each bidding resource, a composite value reflecting a plurality of a work item value, a resource value and a bid; and
comparing the determined composite values to select a resource to service the work item.

14. The method of claim 1, further comprising after the receiving step:
determining whether or not a workload level for the contact center requires the work item that is the subject of the received bids to be serviced by a resource in the set of resources.

15. The method of claim 1, further comprising after the selecting step:
displaying the selected bid and/or information associated with the selected bid to at least some resources in the set of resources; and
receiving additional bids after the displaying step.

16. The method of claim 1, wherein at least some of the resources are human agents.

17. The method of claim 1, wherein the bid is at least one of a monetary service fee, a service time, an opportunity cost to the contact center for servicing the work item, and an overhead cost to the contact center for servicing the work item.

18. The method of claim 1, wherein a plurality of work items are put out for bid and further comprising:
dynamically varying a bidding time for each of the plurality of work items.

19. A computer readable medium containing instructions for performing the steps of claim 1.

20. A logic circuit operable to perform the steps of claim 1.

21. A table maintained in an electronic memory of a contact center, comprising:
an identity of at least one work item;
at least one bid received for the at least one work item; and
for each received bid:
an identity of a resource placing the bid; and
at least one of a value of the resource and a value of the work item.

22. The table of claim 21, further comprising:
a composite value based on the at least one bid and the at least one of a resource value and work item value.

23. The table of claim 21, wherein the at least one of a resource value and work item value comprises both the resource value and the work item value.

24. A contact center for servicing a plurality of contacts received from a plurality of customers, comprising:
a plurality of workstations corresponding to a plurality of resources;
a central server in communication with the plurality of workstations, comprising:
at least one queue of contacts; and
a bid item selecting agent operable to (a) request at least some of the plurality of resources to submit a bid to service at least one contact; (b) receive at least one bid to service the at least one contact; and (c) select a resource from among the plurality of resources to service the at least one contact.

25. The contact center of claim 24, wherein the plurality of workstations are external to the contact center and define a second set of workstations and the plurality of resources define a second set of resources and further comprising:
a first set of workstations corresponding to a first set of resources, wherein the workstations in the first set are internal to the contact center and wherein the workstations in the first workstation set are different from the workstations in the second workstation set.

26. The contact center of claim 25, further comprising at least one second queue for holding contacts to be serviced by the first workstation set, wherein the contacts in the at least one queue of contacts are selected from the at least one second queue.

27. The contact center of claim 24, wherein the central server comprises a workload monitoring agent operable to monitor the at least one queue of contacts and determine, for each contact, at least one of a bid start time, a bidding process duration, and a bid completion time.

28. The contact center of claim 24, wherein the contacts in the at least one queue comprise one or more of realtime and non-real time contacts.

29. The contact center of claim 24, wherein the selecting agent is further operable to identify a set of resources from among the plurality of resources qualified to service the contact; and provide a bid request to each of the resources in the set of resources.

30. The contact center of claim 24, wherein the selecting agent requests, receives and selects bids when a bidding operational mode is in effect but not when a bidding operational mode is not in effect.

31. The contact center of claim 24, wherein the selecting agent is operable, when a predetermined workload level exists in the at least one queue, perform functions (a) through (c) and, when a predetermined workload level does not exist in the at least one queue, not performing functions (a) through (c).

32. The contact center of claim 31, wherein the predetermined workload level exists when there is a likelihood that a service goal for at least one contact in the at least one queue will not be satisfied.

33. The contact center of claim 24, wherein the selecting agent is further operable to determine a time interval for performance of steps (a) through (c).

34. The contact center of claim 27, wherein the monitoring agent is operable to determine, from the at least one queue, a representation of a required queue for at least one goal to be realized for each contact in the at least one queue.

35. The contact center of claim 34, wherein the predetermined workload level exists when a queue position in the required queue is less than a number of enqueued contacts ahead of the queue position in the required queue.

36. The contact center of claim 34, wherein the monitoring agent is operable to determine a time when the predetermined workload level will likely exist.

37. The contact center of claim 34, wherein the monitoring agent is operable to determine a number and identities of contacts to be presented for bidding to the set of resources.

38. The contact center of claim 24, wherein the selecting agent is operable to compare the received bids with a maximum acceptable bid.

39. The contact center of claim 24, wherein the selecting agent is operable to determine, for each bidding resource, a composite value reflecting a one or more of a contact value, a resource value and a bid and compare the determined composite values to select a resource to service the contact.

40. The contact center of claim 24, wherein the selecting agent, after performing the receiving function, is operable to determine whether or not a workload level for the contact center requires the contact that is the subject of the received bids to be serviced by a resource in the plurality of resources.

41. The contact center of claim 24, wherein the selecting agent, after performing the selecting function, is operable to display the selected bid and/or information associated with the selected bid to at least some resources in the plurality of resources and thereafter receive additional bids.

42. The contact center of claim 24, wherein at least some of the resources are human resources.

43. The contact center of claim 24, wherein the bid is at least one of a monetary service fee, a service time, an opportunity cost to the contact center for servicing the work item, and.

44. The contact center of claim 24, wherein a plurality of contacts are put out for bid and the selecting agent is operable to vary dynamically a bidding time for each of the plurality of contacts.

45. A contact center for servicing a plurality of contacts received from a plurality of customers, comprising:
a plurality of workstations corresponding to a plurality of resources;
a server in communication with the plurality of workstations, comprising:
at least one queue of contacts; and
a bid item selecting means for (a) requesting at least some of the plurality of resources to submit a bid to service at least one contact; (b) receiving at least one bid to service the at least one contact; and (c) selecting a resource from among the plurality of resources to service the at least one contact.

46. The contact center of claim 45, wherein the plurality of workstations are external to the contact center and define a second set of workstations and wherein the plurality of resources define a second set of resources and further comprising:
a first set of workstations corresponding to a first set of resources, wherein the workstations in the first workstation set are internal to the contact center and wherein the workstations in the first workstation set are different from the workstations in the second workstation set.

47. The contact center of claim 45, further comprising at least one second queue for holding contacts to be serviced by the workstations in the first workstation set, wherein the contacts in the at least one queue of contacts are selected from the at least one second queue.

48. The contact center of claim 45, wherein the central server comprises a workload monitoring means for monitoring the at least one queue of contacts and determining, for each contact, at least one of a bid start time, a bidding process duration, and a bid completion time.

49. The contact center of claim 45, wherein the contacts in the at least one queue comprise one or more of realtime and non-real time contacts.

50. The contact center of claim 45, wherein the selecting means is further operable to identify a set of resources from among the plurality of resources qualified to service the contact; and provide a bid request to each of the resources in the set of resources.

51. The contact center of claim 45, wherein the selecting means requests, receives and selects bids when a bidding operational mode is in effect but not when a bidding operational mode is not in effect.

52. The contact center of claim 45, wherein the selecting means is operable, when a predetermined workload level exists in the at least one queue, perform functions (a) through (c) and, when a predetermined workload level does not exist in the at least one queue, not performing functions (a) through (c).

53. The contact center of claim 52, wherein the predetermined workload level exists when there is a likelihood that a service goal for at least one contact in the at least one queue will not be satisfied.

54. The contact center of claim 45, wherein the selecting means is further operable to determine a time interval for performance of steps (a) through (c).
